(19) United States
(12) Patent Application Publication
(10) Pub. No.: US 2005/0259090 A1
(43) Pub. Date: Nov. 24, 2005

(54) Display device with a control module for preventing harmonic interference

(75) Inventors: Jui-Ming Wang, Chung Ho City (TW); Bomin Weng, Chung Ho City (TW)

Correspondence Address: OSTROLENK FABER GERB & SOFFEN, 1180 AVENUE OF THE AMERICAS, NEW YORK, NY, 100368403, US

(73) Assignee: Amtran Technology Co., Ltd.

(21) Appl. No.: 10/940,695

(22) Filed: Sep. 14, 2004

(30) Foreign Application Priority Data
May 20, 2004 (TW) 093114239

(51) Int. Cl. G09G 3/36

(52) U.S. Cl. 345/204

(57) ABSTRACT

A display device is adapted for receiving an image signal having a display scanning frequency, and includes an internal light source, a light source adjustment module, and a control module. The light source adjustment module includes a pulse-width-modulation controller that generates a source control signal for controlling turning on and turning off of the internal light source. The control module includes a frequency detecting circuit for detecting the display scanning frequency of the image signal, and a plurality of range adjustment circuits. The frequency detecting circuit actuates one of the range adjustment circuits according to the detected display scanning frequency for subsequent control of the pulse-width-modulation controller such that the latter generates the source control signal within a preset frequency range which has turning on and turning off frequencies that are not integer multiples of the detected display scanning frequency.

### BACKGROUND OF THE INVENTION

1. Field of the Invention

The invention relates to a display device, more particularly to a display device with a control module for preventing harmonic interference.

2. Description of the Related Art

Flat Panel Display (FPD) devices, such as liquid crystal display (LCD), back-projection display and projector devices, have become a trend in display devices. In such FPD devices, for example, a conventional LCD device includes a display panel, a backlighting source module, and a light source adjustment module (such as an inverter) that controls operation of the backlighting source module.

As shown in FIG. 1, adjustment of brightness and contrast in an LCD device is generally realized through adjustment of the amplitude (a) of a power signal 101 applied to the backlighting source module. In actual measurements, adjustment of the amplitude (a) between maximum and minimum values only results in a narrow range of adjustable brightness values, i.e., between 250 cd/m² and 180 cd/m².

Referring to FIG. 2, an LCD device capable of operating in a burst mode is shown to include a power circuit 30, a control unit 31, a transformer unit 32, a feedback unit 33, and a set of light sources 34 (such as lamp tubes).

Unlike the control scheme of FIG. 1, when the amplitude of the power signal is adjusted to the minimum value, the control unit 31 operates in a burst mode, where the control unit 31 receives a width-adjustable square-wave signal 301 and sends out a source control signal 201 to control the light sources 34 through the transformer unit 32 and the feedback unit 33 according to the square-wave signal 301.

In the burst mode, power to the light sources 34 is interrupted intermittently according to the square-wave signal 301. As shown in FIG. 3, the time duration (D) of the source control signal 201 from the control unit 31 in which the light sources 34 are turned on and turned off continuously is so controlled to cause persistence of vision such that a visual lowest brightness output of the light sources 34 is obtained, whereas the time duration (d) corresponds to the turn-off period of the light sources 34. By adjusting the length of the duration (d) in the duration (D), a wider range of adjustable brightness values, for example, between 250 cd/m² and 50 cd/m², is achieved.

However, during the process of adjusting the source control signal 201, if the resulting turn-on/turn-off frequency of the light sources 34 happens to be an integer multiple of a display scanning frequency, this arises in harmonic interference, which will result in a mura phenomenon on the display panel, thereby affecting adversely the quality of the image presented by the LCD device. A similar mura phenomenon also happens in back-projection display and projector devices.

### SUMMARY OF THE INVENTION

Therefore, the object of the present invention is to provide a display device with a control module for preventing harmonic interference so as to overcome the aforesaid mura phenomenon associated with the prior art.

Another object of the present invention is to provide a display device adapted for receiving signals having different scanning frequencies, the display device including a control module for preventing harmonic interference caused by the scanning frequency and the turning on and turning off frequency of the light sources.

Still another object of the present invention is to provide a control module for use in a display device to prevent harmonic interference.

According to one aspect of the present invention, there is provided a display device adapted for receiving an image signal having a display scanning frequency and for presenting an image corresponding to the image signal. The display device comprises an internal light source, a light source adjustment module, and a control module.

The light source adjustment module is coupled electrically to the internal light source, and includes a pulse-width-modulation controller that is operable so as to generate a source control signal for controlling turning on and turning off of the internal light source.

The control module includes a frequency detecting circuit for detecting the display scanning frequency of the image signal, and a plurality of range adjustment circuits, each of which is coupled electrically to the frequency detecting circuit and the pulse-width-modulation controller. The frequency detecting circuit actuates one of the range adjustment circuits according to the display scanning frequency detected thereby. An actuated one of the range adjustment circuits controls the pulse-width-modulation controller such that the pulse-width-modulation controller generates the source control signal within a preset frequency range which corresponds to the actuated one of the range adjustment circuits and which has the turning on and turning off frequencies that are not integer multiples of the display scanning frequency detected by the frequency detecting circuit.

According to another aspect of the present invention, there is provided a control module for preventing harmonic interference in a display device that receives an image signal having a display scanning frequency, and that presents an image corresponding to the image signal. The display device includes an internal light source, and a light source adjustment module that is coupled electrically to the internal light source and that includes a pulse-width-modulation controller. The pulse-width-modulation controller is operable so as to generate a source control signal for controlling turning on and turning off of the internal light source.

The control module comprises a frequency detecting circuit for detecting the display scanning frequency of the image signal, and a plurality of range adjustment circuits, each of which is coupled electrically to the frequency detecting circuit and the pulse-width-modulation controller. The frequency detecting circuit actuates one of the range adjustment circuits according to the display scanning frequency detected thereby. An actuated one of the range adjustment circuits controls the pulse-width-modulation controller such that the pulse-width-modulation controller generates the source control signal within a preset frequency range which corresponds to the actuated one of the range adjustment circuits and which has the turning on and turning off frequencies that are not integer multiples of the display scanning frequency detected by the frequency detecting circuit.

### BRIEF DESCRIPTION OF THE DRAWINGS

Other features and advantages of the present invention will become apparent in the following detailed description of the preferred embodiment with reference to the accompanying drawings, of which:

FIG. 1 illustrates a power signal for adjusting brightness and contrast in a conventional LCD device;

FIG. 2 is a schematic circuit block diagram of a conventional LCD device that is operable in a burst mode;

FIG. 3 illustrates a source control signal generated in the conventional LCD device of FIG. 2;

FIG. 4 is a schematic circuit block diagram of the preferred embodiment of a display device according to the present invention; and

FIG. 5 is another schematic circuit block diagram of the preferred embodiment, illustrating a control module thereof in greater detail.

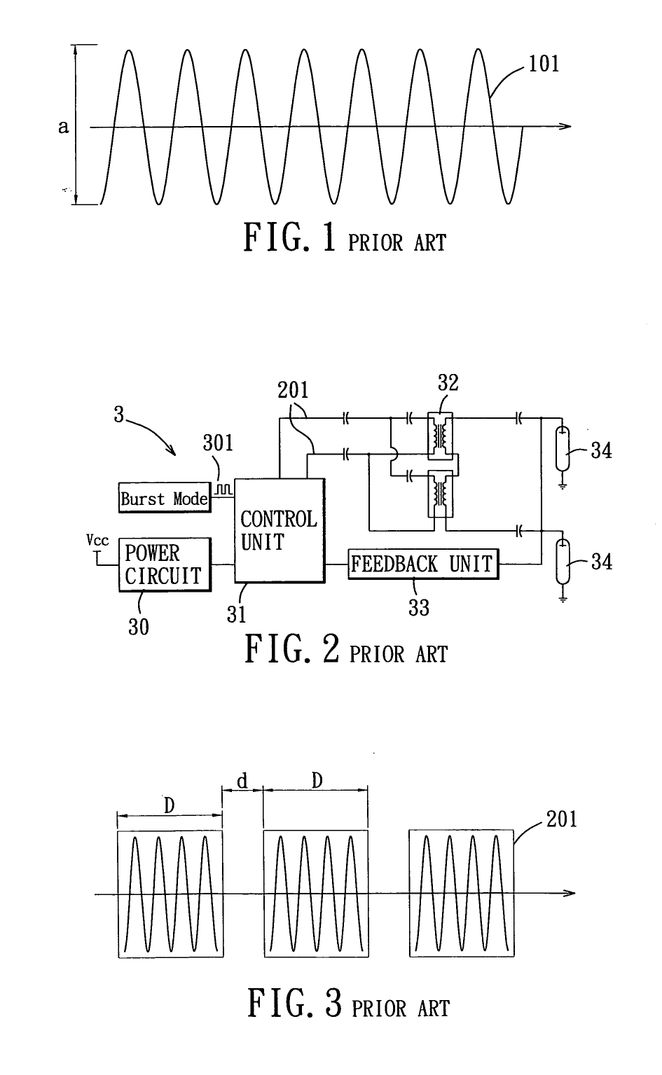

### DETAILED DESCRIPTION OF THE PREFERRED EMBODIMENT

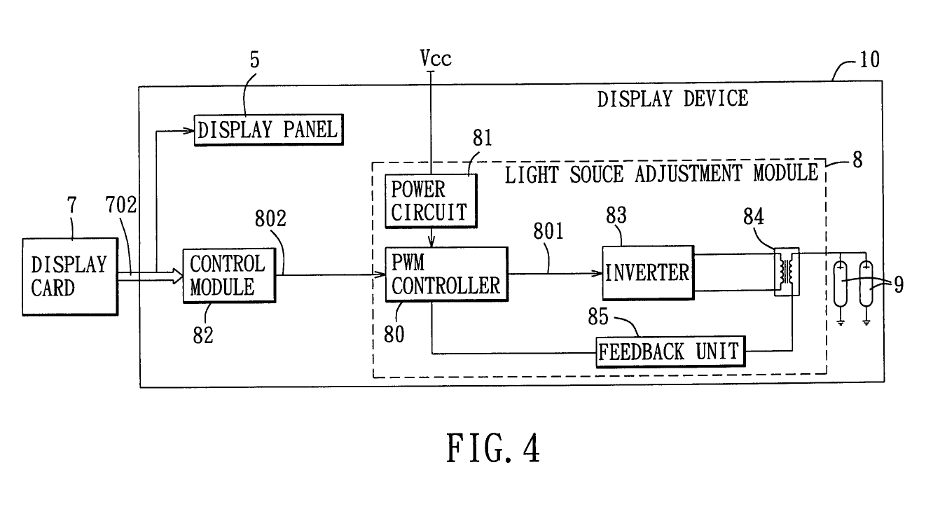

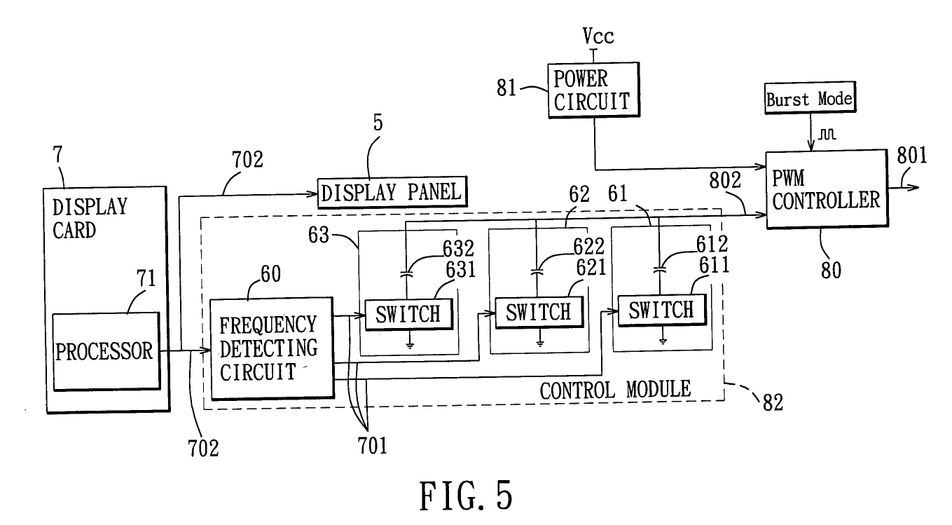

The preferred embodiment of a display device 10 according to the present invention is shown in FIGS. 4 and 5. In this embodiment, the display device 10 is a liquid crystal display device that includes a set of lamp tubes 9, which serves as an internal light source, and a liquid crystal display (LCD) panel 5. In other embodiments, the display device of this invention may be in the form of a back-projection display device, a projection device, etc., and the internal light source may be light emitting diodes.

The display device 10 is adapted for receiving an image signal 702 having a display scanning frequency and for presenting an image corresponding to the image signal 702, and further includes a light source adjustment module 8. The light source adjustment module 8 includes a power circuit 81, a pulse-width-modulation (PWM) controller 80 coupled electrically to the power circuit 81, an inverter 83 coupled to the PWM controller 80, a transformer 84 coupled to the inverter 83 and the internal light source 9, and a feedback unit 85 coupled to the transformer 84 and the PWM controller 80. The PWM controller 80 is operable in a burst mode so as to permit a wide range of adjustable brightness values. When operated in the burst mode, the PWM controller 80 generates a source control signal 801 for controlling turning on and turning off of the internal light source 9. The PWM controller 80 further has a control terminal 802 for receiving a control signal, the amplitude of which is varied such that the PWM controller 80 is able to generate the source control signal 801 within a corresponding frequency range. Since the structures and operations of the inverter 83, the transformer 84 and the feedback unit 85 are well known to those skilled in the art, they will not be described in greater detail hereinafter for the sake of brevity.

In this embodiment, the display device 10 further includes a control module 82 to control operation of the PWM controller 80. The control module 82 includes a frequency detecting circuit 60 for detecting the display scanning frequency of the image signal 702, and a plurality of range adjustment circuits 61, 62, 63, each of which is coupled electrically to the frequency detecting circuit 60 and the control terminal 802 of the PWM controller 80. In this embodiment, the range adjustment circuits 61, 62, 63 are in the form of switch circuits.

In this embodiment, the LCD panel 5 of the display device 10 is exemplified as receiving the image signal 702 from a processor 71 of a graphic display adaptor card (hereinafter referred to as display card 7) of a personal computer. The image signal 702 has a specific display scanning frequency (for example, 75 Hz). The LCD panel 5 is responsive to the image signal 702 in a known manner for presenting an image corresponding thereto. In addition, the frequency detecting circuit 60 is coupled to the display card 7 so as to be able to detect the display scanning frequency of the image signal 702, and is operable so as to generate a status signal 701 corresponding to the detected display scanning frequency for actuating a corresponding one of the range adjustment circuits 61, 62, 63.

To permit a wide range of applications, the number of the range adjustment circuits 61, 62, 63 preferably corresponds to at least the number of standard display scanning frequencies, such as 56, 60, 72, 75 and 85 Hz, that are currently in use. Therefore, in practice, there are at least five range adjustment circuits 61, 62, 63, each of which corresponds to one of the standard display scanning frequencies. For the sake of brevity, only three range adjustment circuits 61, 62, 63 are illustrated in the drawings.

Each of the range adjustment circuits 61, 62, 63 includes a grounding switch 611, 621, 631 coupled to and controlled by the frequency detecting circuit 60, and a capacitor 612, 622, 632 coupled to the grounding switch 611, 621, 631 at one terminal end and adapted to be coupled to the control terminal 802 of the PWM controller 80 at another terminal end. The capacitors 612, 622, 632 of the range adjustment circuits 61, 62, 63 have different capacitance values, and the grounding switches 611, 621, 631 are normally open switches that are closed only when actuated by the presence of the status signal 701 at a dedicated control line coming from the frequency detecting circuit 60.

In the following illustrative example, it is assumed that the range adjustment circuits 61, 62, 63 are configured to correspond to the standard display scanning frequencies of 60 Hz, 75 Hz and 85 Hz, respectively. When the frequency detecting circuit 60 detects that the display scanning frequency of the image signal 702 is 60 Hz, the status signal 701 from the frequency detecting circuit 60 actuates the grounding switch 611 of the range adjustment circuit 61 such that the corresponding capacitor 612 is grounded. As a result, the voltage at the control terminal 802 of the PWM controller 80 is adjusted such that the latter outputs the pulsating source control signal 801 having the turning on and turning off frequencies within a preset frequency range of 215 and 225 Hz, which are not integer multiples (i.e., 60, 120, 180, 240 . . . Hz) of the display scanning frequency detected by the frequency detecting circuit 60.

On the other hand, when the frequency detecting circuit 60 detects that the display scanning frequency of the image signal 702 is 75 Hz, the status signal 701 from the frequency detecting circuit 60 actuates the grounding switch 621 of the range adjustment circuit 62 such that the corresponding capacitor 622 is grounded. As a result, the voltage at the control terminal 802 of the PWM controller 80 is adjusted such that the latter outputs the pulsating source control signal 801 having the turning on and turning off frequencies within a preset frequency range of 240 and 255 Hz, which are not integer multiples (i.e., 75, 150, 225, 300 . . . Hz) of the display scanning frequency detected by the frequency detecting circuit 60.

In the same manner, when the frequency detecting circuit 60 detects that the display scanning frequency of the image signal 702 is 85 Hz, the status signal 701 from the frequency detecting circuit 60 actuates the grounding switch 631 of the range adjustment circuit 63 such that the corresponding capacitor 632 is grounded. As a result, the voltage at the control terminal 802 of the PWM controller 80 is adjusted such that the latter outputs the pulsating source control signal 801 having the turning on and turning off frequencies within a preset frequency range of 230 and 245 Hz, which are not integer multiples (i.e., 85, 170, 255 . . . Hz) of the display scanning frequency detected by the frequency detecting circuit 60.

It has thus been shown that, based on the display scanning frequency detected by the frequency detecting circuit 60, the grounding switch 611, 621, 631 of one of the range adjustment circuits 61, 62, 63 will be actuated by the frequency detecting circuit 60. Since the capacitors 612, 622, 632 of the range adjustment circuits 61, 62, 63 have different capacitance values, the voltage at the control terminal 802 of the PWM controller 80 will vary according to the detected display scanning frequency, thereby enabling the PWM controller 80 to generate the source control signal 801 within a preset frequency range which corresponds to the actuated one of the range adjustment circuits 61, 62, 63 and which has the turning on and turning off frequencies that are not integer multiples of the display scanning frequency detected by the frequency detecting circuit 60. As a result, harmonic interference and the mura phenomenon associated with such interference can be avoided, thus preserving the quality of the image presented by the display device 10.

It should be noted herein that the image signal 702 can be those generated by audio-video signal sources other than a display card 7. Moreover, in this embodiment, the capacitors 612, 622, 632 of the range adjustment circuits 61, 62, 63 have different capacitance values so that the voltage at the control terminal 802 of the PWM controller 80 can be varied according to the detected display scanning frequency. However, in applications where the PWM controller 80 is built with a set of available control terminals, the PWM controller 80 may be configured to identify actuated and non-actuated states of the range adjustment circuits 61, 62, 63 without the need for the capacitors 612, 622, 632.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A display device adapted for receiving an image signal having a display scanning frequency and for presenting an image corresponding to the image signal, said display device comprising:
an internal light source;
a light source adjustment module coupled electrically to said internal light source, and including a pulse-width-modulation controller that is operable so as to generate a source control signal for controlling turning on and turning off of said internal light source; and
a control module including
a frequency detecting circuit for detecting the display scanning frequency of the image signal, and
a plurality of range adjustment circuits, each of which is coupled electrically to said frequency detecting circuit and said pulse-width-modulation controller,
said frequency detecting circuit actuating one of said range adjustment circuits according to the display scanning frequency detected thereby,
an actuated one of said range adjustment circuits controlling said pulse-width-modulation controller such that said pulse-width-modulation controller generates the source control signal within a preset frequency range which corresponds to the actuated one of said range adjustment circuits and which has the turning on and turning off frequencies that are not integer multiples of the display scanning frequency detected by said frequency detecting circuit.

2. The display device as claimed in claim 1, wherein said pulse-width-modulation controller is operated in a burst mode.

3. The display device as claimed in claim 1, wherein each of said range adjustment circuits includes a grounding switch coupled to and controlled by said frequency detecting circuit, and a capacitor coupled between said grounding switch and said pulse-width-modulation controller.

4. The display device as claimed in claim 1, wherein said display device is a liquid crystal display device, and said internal light source includes a lamp tube or light emitting diodes.

5. The display device as claimed in claim 1, wherein said display device is a back-projection display device, and said internal light source includes a lamp tube or light emitting diodes.

6. The display device as claimed in claim 1, wherein said display device is a projection device, and said internal light source includes a lamp tube or light emitting diodes.

7. A control module for preventing harmonic interference in a display device,
the display device receiving an image signal having a display scanning frequency, and presenting an image corresponding to the image signal,
the display device including an internal light source, and a light source adjustment module coupled electrically to the internal light source, the light source adjustment module including a pulse-width-modulation controller that is operable so as to generate a source control signal for controlling turning on and turning off of the internal light source,
said control module comprising:
a frequency detecting circuit adapted for detecting the display scanning frequency of the image signal; and
a plurality of range adjustment circuits, each of which is coupled electrically to said frequency detecting circuit and is adapted to be coupled electrically to the pulse-width-modulation controller;
said frequency detecting circuit actuating one of said range adjustment circuits according to the display scanning frequency detected thereby;
an actuated one of said range adjustment circuits controlling the pulse-width-modulation controller such that the pulse-width-modulation controller generates the source control signal within a preset frequency range which corresponds to the actuated one of said range adjustment circuits and which has the turning on and turning off frequencies that are not integer multiples of the display scanning frequency detected by said frequency detecting circuit.

8. The control module as claimed in claim 7, wherein each of said range adjustment circuits includes a grounding switch coupled to and controlled by said frequency detecting circuit, and a capacitor coupled to said grounding switch at one terminal end and adapted to be coupled to the pulse-width-modulation controller at another terminal end.

9. A display device adapted for receiving an image signal having a display scanning frequency and for presenting an image corresponding to the image signal, said display device comprising:
an internal light source;
a light source adjustment module coupled electrically to said internal light source, and including a pulse-width-modulation controller that is operable so as to generate a source control signal for controlling turning on and turning off of said internal light source; and
a control module including
a frequency detecting circuit for detecting the display scanning frequency of the image signal, and
a plurality of switch circuits, each of which is coupled electrically to said frequency detecting circuit and said pulse-width-modulation controller;
said frequency detecting circuit actuating one of said switch circuits according to the display scanning frequency detected thereby,
an actuated one of said switch circuits controlling said pulse-width-modulation controller such that said pulse-width-modulation controller generates the source control signal within a preset frequency range which corresponds to the actuated one of said switch circuits and which has the turning on and turning off frequencies that are not integer multiples of the display scanning frequency detected by said frequency detecting circuit.

10. A control module for preventing harmonic interference in a display device,
the display device receiving an image signal having a display scanning frequency, and presenting an image corresponding to the image signal,
the display device including an internal light source, and a light source adjustment module coupled electrically to the internal light source, the light source adjustment module including a pulse-width-modulation controller that is operable so as to generate a source control signal for controlling turning on and turning off of the internal light source,
said control module comprising:
a frequency detecting circuit adapted for detecting the display scanning frequency of the image signal; and
a plurality of switch circuits, each of which is coupled electrically to said frequency detecting circuit and is adapted to be coupled electrically to the pulse-width-modulation controller;
said frequency detecting circuit actuating one of said switch circuits according to the display scanning frequency detected thereby;
an actuated one of said switch circuits controlling the pulse-width-modulation controller such that the pulse-width-modulation controller generates the source control signal within a preset frequency range which corresponds to the actuated one of said switch circuits and which has the turning on and turning off frequencies that are not integer multiples of the display scanning frequency detected by said frequency detecting circuit.
